(19) United States
(12) Patent Application Publication
(10) Pub. No.: US 2007/0076445 A1
(43) Pub. Date: Apr. 5, 2007

(54) Power converter

(75) Inventor: Ulrich Böke, Langerwehe (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/575,422

(22) PCT Filed: Oct. 6, 2004
(86) PCT No.: PCT/IB04/51990

§ 371 Date: Apr. 10, 2006

(30) Foreign Application Priority Data
Oct. 13, 2003 (EP) 03103769.0

(51) Int. Cl. H02M 3/335

(52) U.S. Cl. 363/17

(57) ABSTRACT

Power converters adapted for providing a plurality of n+1 control parameters for independently supplying a plurality of n lamps and one DC current consumer, usually comprise n inverters, one for each lamp. The power converter (10-50) according to an exemplary embodiment of the present invention provides an independent control of each lamp by using n tunable resonant circuits (L2,L3,C5-C8) but only one space-consuming inverter (30) and one transformer (Tr. 1), wherein each tunable resonant circuit comprises a magnetic amplifier (L2,L3). Advantageously, this leads to a reduction in size, which may lead to more compact and cheaper LCD applications.

The present invention relates to electronic power conversion. More particularly, the present invention relates to a power converter and a liquid crystal display comprising a power converter.

Power conversion is an important issue for supplying the right amount of electric energy to an electronic circuit or other electrically driven components or devices. An example of such an electrically driven device using a power conversion is a liquid crystal display (hereinafter referred to as “LCD”), which may be used in a television set (hereinafter referred to as “LCD-TV”). The backlighting of the LCD consumes a large amount of electric power. A 30″ LCD-TV consumes about 100 W power for the backlights and about 10 W power for signal processing. Furthermore, a LCD backlighting with fluorescent lamps requires a power supply with AC current sources and operating frequencies of 40 kHz to 80 kHz. These operating frequencies are significantly higher than the AC mains frequency of 50 Hz or 60 Hz. Therefore, applications with LCD displays require a dedicated power supply unit or power converter.

WO 00/38483 A1 discloses a DC-AC inverter for driving multiple fluorescent lamps. The circuit generates a first AC voltage by using a LCC resonant inverter. It should be noted that L refers to an inductivity or inductor and C refers to a capacitor. The first AC voltage is changed into a second AC voltage by using a transformer. The second AC voltage must be higher than the required ignition voltage of the supplied fluorescent lamps. The switching frequency of the LCC resonant inverter is the only control parameter of such a lamp driver. Therefore, only one parameter can be controlled. Typically, this one controllable parameter is the sum of all lamp power levels. If the controlled lamp power is changed, the two AC voltages change as well. Therefore, a constant DC output voltage cannot be generated with an additional transformer winding and rectifier circuit without additional control parameter.

U.S. Pat. No. 6,023,131 discloses a backlight device for a liquid crystal display. One thyristor is connected in series with each lamp as a control means.

Thyristors may withstand an ignition voltage of thin fluorescent lamps of about 2000 to 3000 Volts peak, but have the disadvantage of being big and expensive. Therefore, the independent control of multiple fluorescent lamps in a single LCD backlighting system is realized today only with multiple DC-AC inverters, wherein each lamp has its own individual inverter. Such power conversion systems or power converters have the disadvantage of being rather big in size. This is particularly true for backlighting systems which are comprising LCDs with a size of 28″ or more and therefore are comprising 12 to 20 lamps, or even more.

It is an object of the present invention to provide for an improved power conversion.

According to an exemplary embodiment of the present invention as set forth in claim 1, the above object may be solved by a power converter comprising a controller circuit with at least one tunable resonant circuit, wherein each tunable resonant circuit of the at least one tunable resonant circuit comprises a magnetic amplifier.

In other words, according to this exemplary embodiment of the present invention, a power converter is provided, which comprises at least one magnetic amplifier. Each of the at least one magnetic amplifiers is integrated and forms part of a corresponding tunable resonant circuit, wherein each of the at least one tunable resonant circuits controls a corresponding lamp.

Therefore, many different lamps may be supplied with electric current independently from each other.

According to another exemplary embodiment of the present invention as set forth in claim 2, each tunable resonant circuit of the at least one tunable resonant circuit controls the operation of one of a fluorescent lamp and a low pressure lamp. The fluorescent lamps may be part of a background lighting of a LCD, wherein each of the fluorescent lamps may be supplied with electric current or electric voltage independently from each other, which allows for a so-called scanning backlight which may compensate the sample and hold effect and therefore motion blur of LCDs showing moving pictures.

According to an aspect of this exemplary embodiment of the present invention, fluorescent gas discharge lamps may be controlled by the tunable resonant circuits of the power converter. Advantageously, the fluorescent gas discharge lamps may be used for general illumination of, for example, rooms.

According to another exemplary embodiment of the present invention as set forth in claim 3, the power converter comprises a halfbridge circuit for converting a DC input voltage into a first AC voltage, the halfbridge circuit comprising a first power semiconductor, a second power semiconductor, and a first control circuit. Furthermore, the power converter comprises a first capacitor. Advantageously, this first capacitor filters out a DC component of an output voltage of the halfbridge circuit, resulting in a pure first AC voltage at the output of the halfbridge circuit.

Advantageously, the first control circuit turns on the first and second power semiconductor alternating and periodically with equal conduction time intervals. Advantageously, there is a short time interval of e.g. 200 nanoseconds to 1000 nanoseconds between the two on-time periods of the first and second power semiconductor's operation, in which the two power semiconductors are both turned off. In this time interval, called “dead time” or “non-overlap time”, the stored energy in the mutual inductance of the transformer and the related current results overall in low switching losses of the two power semiconductors.

The first AC voltage of the halfbridge circuit is then supplied to a primary winding of a transformer for isolating the halfbridge circuit from the at least one tunable resonant circuit. Furthermore, the at least one tunable resonant circuit is connected to a second winding of the transformer. Advantageously, the isolation provides a mains isolation of the at least one tunable resonant circuit from the mains voltage supply.

According to another exemplary embodiment of the present invention as set forth in claim 4, the power converter further comprises a rectifier circuit for converting a third AC voltage into a DC output voltage. The rectifier circuit comprises a third winding of the transformer for isolating the halfbridge circuit from the rectifier circuit, a series inductor and a plurality of series capacitors. The third winding of the transformer hereby generates the third AC voltage to supply the rectifier circuit. The series inductor and the plurality of series capacitors form a series resonant converter and the series resonant converter is tuned to the operating frequency of the rectifier circuit. Advantageously, the additional third transformer winding and the rectifier circuit provides for a DC supply voltage with a minimum of effort. The DC supply voltage may be supplied to an LCD display, which requires a DC supply voltage, which is significantly lower than the DC input voltage of the halfbridge circuit.

According to another exemplary embodiment of the present invention as set forth in claim 5, each tunable resonant circuit is electrically connected to the second winding and to a fourth winding of the transformer. The two windings of the transformer generate two AC voltages of opposite polarities or signs. Advantageously, according to this exemplary embodiment of the present invention, parasitic capacitances between a fluorescent lamp and a grounded metal part, e.g. a reflector, may conduct less leakage current due to a lower electric field between lamp and ground. Furthermore, cables and connectors are also stressed only with the half-length voltage. This may be of interest for LC displays of a size of 30″ and more using very long and thin cold cathode fluorescent lamps with starting voltages of 3000 volts and more.

According to another exemplary embodiment of the present invention as set forth in claim 6, the halfbridge circuit comprises a second control circuit and the second control circuit controls the switching frequency of the halfbridge circuit as a function of the DC input voltage.

Advantageously, according to an aspect of this exemplary embodiment of the present invention, the second control circuit may comprise an integrated voltage-controlled oscillator, which generates the switching frequency of the two power semiconductors and therefore the switching frequency of the halfbridge circuit. The integrated voltage controlled oscillator may be used to reduce the switching frequency proportional to the DC input voltage to compensate the influence of a decreasing DC input voltage into the transferred power in a mains dip case by using the voltage gain function of the controller circuit and the rectifier circuit.

According to another exemplary embodiment of the present invention as set forth in claim 7, the rectifier circuit comprises a full bridge diode rectifier and a series-parallel resonant circuit, wherein the series-parallel resonant circuit comprises a first inductor or inductivity, a second inductor or inductivity, a second capacitor or capacity, and a third capacitor or capacity. The series-parallel resonant circuit is connected to the third winding of the transformer. The series-parallel resonant circuit may be adapted in such a way that it provides an AC-gain characteristic which is comparable to the frequency characteristic of a first tunable resonant circuit of the at least one tunable resonant circuit in the lamp control unit, which drives a lamp of the backlighting. Advantageously, by using this set-up, a voltage drop of the DC input voltage during a mains dip may be partly compensated by changing the switching frequency of the halfbridge circuit by means of the second control circuit.

According to another exemplary embodiment of the present invention as set forth in claim 8, the power converter comprises a feedback circuit. The feedback circuit comprises a third control circuit, wherein the third control circuit is adapted for adjusting the switching frequency of the halfbridge circuit in order to control the DC output voltage.

Advantageously, this exemplary embodiment of the present invention provides a very effective use of the available control parameters. The switching frequency of the two power semiconductors is used in the control loop to regulate the DC output voltage, while adjustable inductors are used to control the current in each lamp.

According to another exemplary embodiment of the present invention as set forth in claim 9, the power converter further comprises a mains rectifier circuit and a boost converter, wherein the mains rectifier circuit provides a first DC voltage to the boost converter and wherein the boost converter provides a DC input voltage to the halfbridge circuit. An own controller stabilizes this DC input voltage. Advantageously, according to this exemplary embodiment of the present invention, the special operation condition of a mains dip may result in a smaller fluctuation of the DC input voltage range of the halfbridge converter.

According to another exemplary embodiment of the present invention as set forth in claim 10, a liquid crystal display is provided, wherein the liquid crystal display comprises a power converter and wherein the power converter comprises a controller circuit with at least one tunable resonant circuit. Each tunable resonant circuit of the at least one tunable resonant circuit comprises a magnetic amplifier.

In other words, according to this exemplary embodiment of the present invention, a liquid crystal display is provided, which comprises a power converter with at least one magnetic amplifier. Each of the at least one magnetic amplifiers is integrated and forms part of a corresponding tunable resonant circuit, wherein each of the at least one tunable resonant circuits controls a corresponding lamp.

Therefore, many different lamps may be supplied with electric current independently from each other.

According to another exemplary embodiment of the present invention as set forth in claim 11, the liquid crystal display further comprises a halfbridge circuit, which comprises a first power semiconductor, a second power semiconductor and a first control circuit. Furthermore, the liquid crystal display comprises a first capacitor for blocking a first DC output voltage of the halfbridge and a controller circuit with at least one tunable resonant circuit. The first control circuit turns on the first and second power semiconductors periodically with equal conduction time intervals, wherein the first and the second power semiconductors are operated with a non-overlap time interval of zero conduction between two consecutive conduction time intervals for a minimization of switching losses. The first AC voltage is supplied to a primary winding of a transformer for isolating the halfbridge circuit from the at least one tunable resonant circuit, which is connected to a second winding of the transformer. Furthermore, each tunable resonant circuit of the at least one tunable resonant circuit comprises a magnetic amplifier and controls the operation of a fluorescent lamp.

Advantageously, according to this exemplary embodiment of the present invention, each of the fluorescent lamps may be supplied with electric current and voltage independently from each other, which allows for a so-called scanning backlight which may compensate the sample and hold effect and therefore motion blur of LCDs showing moving pictures.

Advantageously, according to this exemplary embodiment of the present invention, there is a short time interval of e.g. 200 nanoseconds to 1000 nanoseconds between the two on-time periods of the first and second power semiconductor's operation, in which the two power semiconductors are both turned off. In this time interval, called “dead time” or “non-overlap time”, the stored energy in the mutual inductance of the transformer and the related current results overall in low switching losses of the two power semiconductors.

It may be seen as a gist of an exemplary embodiment of the present invention that the power converter provides an independent control of each lamp of a plurality of fluorescent gas discharge lamps by using a plurality of tunable resonant circuits, one tunable resonant circuit for each lamp, wherein each tunable resonant circuit comprises a magnetic amplifier. Advantageously, only one DC/AC inverter is needed, leading to a reduction in size, which may be of particular interest in backlighting systems of large LCDs comprising 12 or more lamps.

These and other aspects of the present invention will become apparent from and elucidated with reference to the embodiments described hereinafter.

Exemplary embodiments of the present invention will be described below with reference to the following drawings:

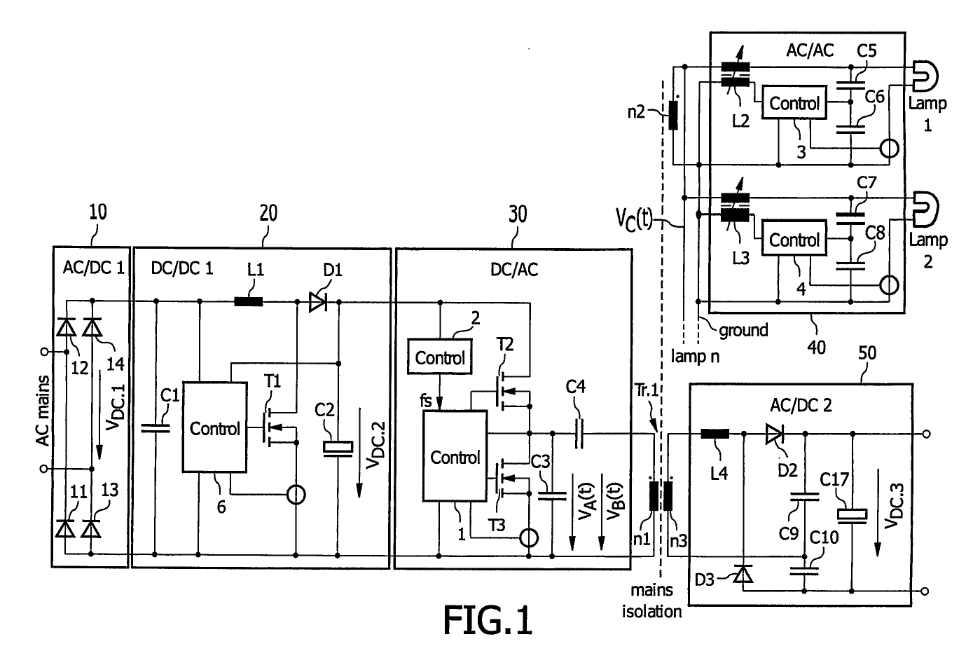

FIG. 1 shows a schematic circuit diagram of a power converter according to an exemplary embodiment of the present invention.

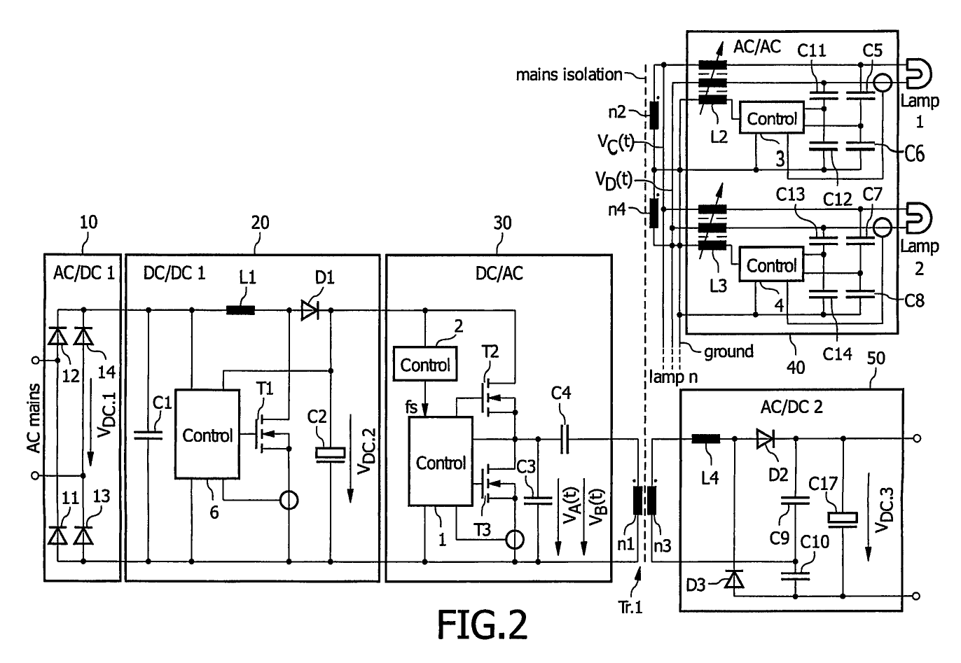

FIG. 2 shows a schematic circuit diagram of another exemplary embodiment of the power converter according to the present invention.

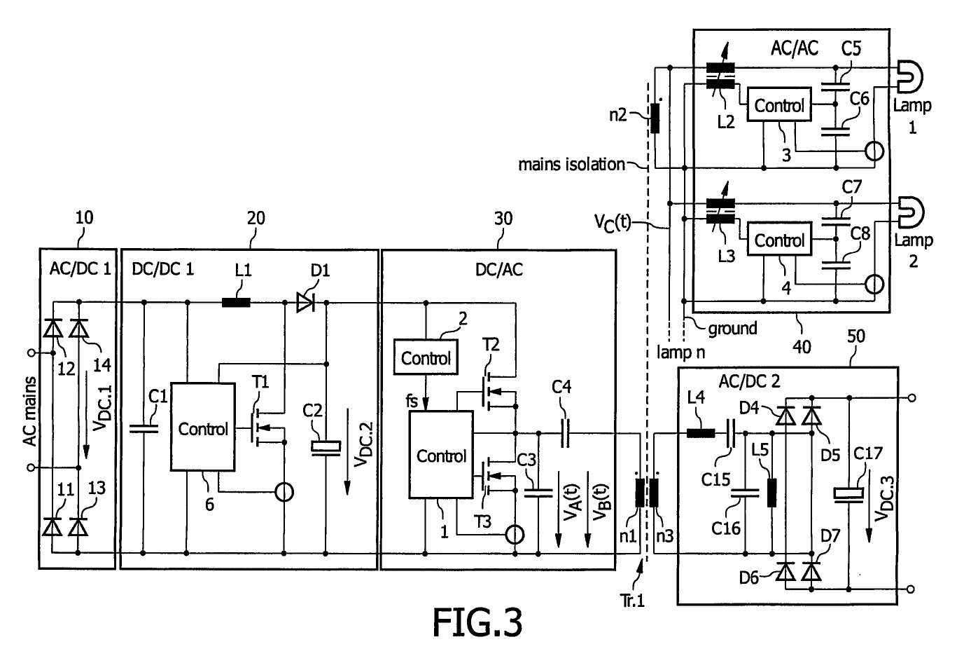

FIG. 3 shows a schematic circuit diagram of another exemplary embodiment of the power converter according to the present invention.

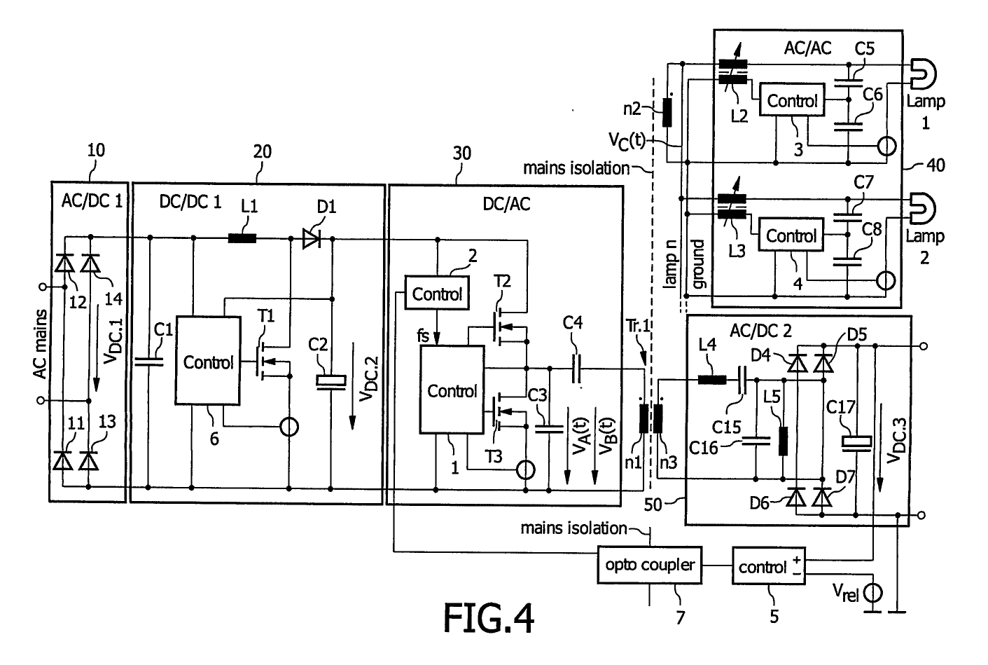

FIG. 4 shows another exemplary embodiment of the power converter according to the present invention.

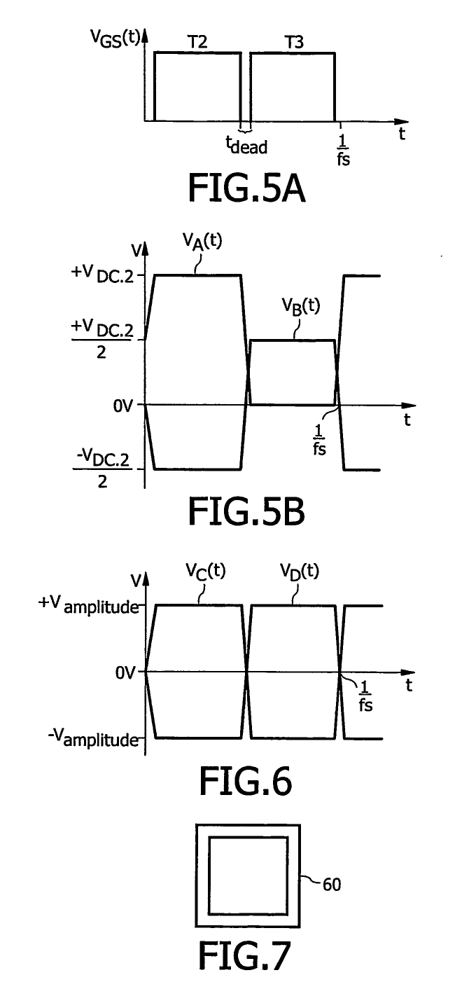

FIG. 5a shows a time dependence of a gate-source voltage of a power semiconductor according to an exemplary embodiment of the present invention.

FIG. 5b shows a time dependence of an internal halfbridge output voltage V_{A}(t) and a halfbridge output voltage or first AC voltage V_{B}(t).

FIG. 6 shows a time dependence of output voltages of the second and fourth transformer windings n2 and n4, respectively.

FIG. 7 shows a schematic representation of a liquid crystal display according to an exemplary embodiment of the present invention.

For the description of FIGS. 1 to 7, the same reference numerals are used for the same or corresponding elements.

The schematic circuit diagram depicted in FIG. 1 shows a power converter according to an exemplary embodiment of the present invention. The power converter may be divided into 5 sub-circuits, namely a main rectifier circuit 10 or mains rectifier front end 10 including an AC/DC converter, a boost converter circuit 20 or DC/DC converter, a halfbridge circuit 30 or DC/AC inverter, a transformer Tr1, comprising a first transformer winding n1, a second transformer winding n2 and a third transformer winding n3, a controller circuit 40 or AC/AC inverter and a rectifier circuit 50 or AC/DC rectifier.

The power converter according to the present invention may be adapted to drive any kind of fluorescent gas discharge lamp in LCD backlighting systems. The fluorescent gas discharge lamp may be a so-called hot cathode fluorescent lamp known from general lighting applications as well as a so-called cold cathode fluorescent lamp or capacity-coupled fluorescent lamp. It should be noted that all these different types of fluorescent lamps may have different starting voltages and different load impedances which are input parameters for the design of the power converter.

The AC/AC inverter or controller circuit 40 comprises a plurality of AC networks, one for each lamp of the LCD backlighting, to convert the AC voltage of the second transformer winding n2 into an AC current in a fluorescent lamp. In principle, a whole plurality of rectifier circuits 50 may be provided for generating different DC output voltages. Therefore, this architecture is called a scalable system, which has been named Scarlet.

The mains rectifier circuit 10 comprises an AC mains input for input voltages between about 90 volts to 264 volts. Furthermore, the mains rectifier circuit 10 comprises four diodes 11, 12, 13, 14, which are arranged in such a way that the AC mains voltage is rectified, resulting in a DC voltage V_{DC.1} ranging from 0 volts to 370 volts. The rectified DC voltage V_{DC.1} at the output of the mains rectifier circuit 10 may have the form of sinus-shaped half waves.

The boost converter circuit 20 comprises a capacitor C1, a control circuit 6, an inductor L1, a diode D1, an output capacitor C2 and a switch T1. The switch T1 may be implemented in the form of a metal oxide semiconductor field effect transistor (hereinafter referred to as “MOSFET-transistor”). The control input of the switch T1, i.e. the gate-electrode of the MOSFET-transistor switch, is connected to an output of the control circuit 6.

Mains rectifier circuit 10 and boost converter circuit 20 provide a stabilized DC input voltage V_{DC.2} to the halfbridge circuit 30. Both the mains rectifier circuit 10 and the boost converter circuit 20, which are used for providing the stabilized DC voltage, are well known in the art and will therefore not be described in great detail. The output voltage of the boost converter circuit 20 may be regulated in normal operation to a value of e.g. 400 volts. A special operation condition of a boost converter circuit 20 according to the present invention is a mains dip. In such a case, the AC mains voltage is turned off for a short time interval of e.g. 20 ms. During this time interval, the output capacitor C2 of the boost converter circuit 20 may not be charged by the boost converter and the Scarlet circuit or power converter discharges C2, for example down to 300 volts. This may result in an increased DC input voltage V_{DC.2} range of the Scarlet circuit under the special operation condition of a mains dip.

The halfbridge circuit 30 comprises a first control circuit 1, a second control circuit 2, a first power semiconductor T2, a second power semiconductor T3, a first capacitor C4 and a capacitor C3 to limit the voltage rise time of V_{A}(t). The two power semiconductors T2, T3, may each be implemented in the form of a respective power MOSFET in a halfbridge configuration and may be used to generate a pulsed DC voltage V_{A}(t). Capacitor C4 filters out the DC component of V_{A}(t) in order to generate a pure AC voltage V_{B}(t). Both voltages are shown in FIG. 5b. The capacitance value of C4 is high, such that its AC impedance at operating frequency is low, resulting in a low AC voltage drop of C4.

The second control circuit 2 turns on both power semiconductors T2 and T3 alternately with equal on-time periods. Between two consecutive on-time periods or induction time intervals lies a non-overlap time interval of zero conduction of, for example, 200 ns to 1000 ns in which these two power semiconductors are both turned off. During this time interval, which is called “dead time” or “non-overlap time”, the stored energy in the mutual inductance of the first transformer winding n1 and the related current changes the voltage of C3, resulting in low switching losses of the two power semiconductors T2 and T3 and a limited voltage rise and fall time of the capacitor C3. The peak current of power semiconductor T3 may be monitored to protect the halfbridge against over current.

The second control circuit 2 generates the switching frequency of the two power semiconductors T2 and T3. The generation of the switching frequency may be performed by means of an integrated voltage controlled oscillator (non depicted in FIG. 1). The integrated voltage controlled oscillator may be used to reduce the switching frequency proportional to the DC input voltage to compensate the influence of a decreasing DC input voltage V_{DC.2} into the transferred power in a mains dip case by using the voltage gain function of the controller circuit 40 and the rectifier circuit 50.

The transformer Tr1 is used with a first transformer winding n1, a second transformer winding n2, a third transformer winding n3 and a fourth transformer winding n4 (see FIG. 2) in order to isolate the controller circuit 40 and the rectifier circuit 50 from the mains voltage and to change the input voltage from the halfbridge circuit 30 V_{B}(t) into the required voltage values need for driving the AC/AC inverter or controller circuit 40 with AC bus voltages V_{C}(t) and V_{D}(t), as depicted in FIG. 2. The first transformer winding n1 is supplied by the halfbridge circuit 30, the second and fourth transformer windings n2 and n4, respectively, supply the controller circuit 40 and the third transformer winding n3 supplies rectifier circuit 50.

An advantage of the Scarlet circuit or power converter according to an exemplary embodiment of the present invention, is a moderate voltage stress of the transformer Tr1. The maximum voltage is typically generated with windings n2 or n4 (see FIG. 2). This voltage is about the lamp voltage in normal operation. The higher ignition voltage of a fluorescent lamp is generated with a resonant circuit, for example L2 and C5 in FIG. 1 for the short moment of lamp ignition. Therefore, a transformer Tr1 of a Scarlet circuit is smaller and cheaper compared with transformers in known DC/AC inverter circuits, which are often continuously generating the ignition voltage of a supplied fluorescent lamp.

The AC/AC inverter circuit or controller circuit 40 comprises adjustable inductors or magnetic amplifiers L2 and L3, a first controller circuit 3, a second controller circuit 4, capacitors C5, C6, C7 and C8. The second transformer winding n2 supplies a transformed AC voltage V_{C}(t) to the controller circuit 40. This AC voltage is transformed from the first AC voltage at the first transformer winding n1 to the second AC voltage at the second transformer winding n2.

The independent control of each lamp, e.g. lamp 1 and lamp 2 in FIGS. 1 to 4, is realized in the power conversion circuit with its own adjustable resonant circuit and control circuit per lamp. The control means of the adjustable resonant circuits are adjustable inductors, L2 and L3. Adjustable inductors are known as magnetic amplifiers. The magnetic amplifiers comprise at least two windings. The first winding is the power inductor, the second winding is used to saturate the magnetic conducting material in the inductor with a DC control current. Once this control current is flowing, the magnetic part is saturated, a reduction of the inductance value of the power inductor is the result.

A method of operating a fluorescent lamp with this control technique is as follows:

At the beginning the lamp is off and the inductance value of L2 is maximum, due to a zero control current. The resonance frequency of the resonant circuit with L2 and C5 is below the operating frequency of the halfbridge circuit 30. Secondly, the control current in L2 is increasing, inductance value and impedance of L2 are decreasing. The AC current in L2, C5 and C6 is increasing and therefore also the voltage at C5 and C6. In this operation mode, the first controller circuit 3 limits the maximum voltage of C5 and C6 to protect the components from damage. C5 and C6 are a capacitive voltage divider with the main voltage drop at C5. Thus, the capacitor C6 has very little influence on the resonant circuit with L2 and C5. Once the voltage of C5 and C6 has reached the required starting voltage or ignition voltage, the fluorescent lamp starts to conduct a part of the current L2. Now, the lamp is on and the power flow in the lamp can be changed by changing control current and with it the impedance of L2. In this operation mode, the first controller circuit 1 controls the brightness of the lamp by monitoring the lamp current By reducing the control current again to zero, the impedance of L2 increases and the current in L2 is reduced to that amount of current, which is flowing through C5 and C6 such that the lamp goes off, since no current is flowing in lamp 1 any longer. The second control circuit 4 together with magnetic amplifier L3 and capacitors C7 and C8 operate accordingly and control lamp 2.

The rectifier circuit 50 comprises a third transformer winding n3, inductor LA, diodes D2, D3, capacitors C9, C10 and output capacitor C17.

The third transformer winding n3 supplies an AC voltage to the rectifier circuit 50. This AC voltage is transformed from the first AC voltage at the first transformer winding n1 to the third AC voltage at transformer winding n3. The rectifier circuit 50 outputs a DC supply voltage, which may be used for supplying an LC display with a DC output voltage which is significantly lower than the DC input voltage at the halfbridge circuit 30.

The value of DC voltage V_{DC.3} may be set by the number of turns of winding n3 It is typically much lower than the amplitude of V_{B}(t), in order to supply other circuits of a display-like signal processing and audio amplifier.

Furthermore, this DC output voltage is electrically isolated from the mains voltage. This DC voltage supply is realized in the so-called Scarlet circuit or power converter, according to an exemplary embodiment of the present invention, with the minimum effort of an additional transformer winding n3 and rectifier circuit 50. Diodes D2 and D3 and capacitors C9 and C10 are arranged such that they operate as a so-called voltage doubler. Since the rectifier circuit 50 does not include its own control means, DC output voltage V_{DC.2} may change for two reasons. Firstly, the DC input voltage V_{DC.2} may drop in the case of a mains dip, which cannot be compensated for by the boost converter circuit 20. Secondly, DC output voltage V_{DC.2} may change, if the load current of the DC output changes due to the voltage drop of the internal impedance of transformer and rectifier circuit. A significant contribution to the impedance comes from the leakage inductance of the transformer.

This impedance may be compensated in rectifier circuit 50 by the impedance of capacitors C9 and C10. The AC current in the third transformer winding n3 charges at the same time one of these two capacitors while the second one is discharged. Therefore, the effective AC impedance of these two capacitors is the sum of C9 and C10. To compensate finally the load-dependent voltage drop of DC output voltage V_{DC.3} in the best way, the resonance frequency of a series resonant circuit is designed close to the switching frequency of the DC/AC inverter or halfbridge circuit 30. The series resonant inductor of this series resonant circuit is L4 and the leakage inductance of the third transformer winding n3 is a part of L4. The series resonant capacitance of the resonant circuit is the sum of C9 and C10.

Capacitor C17 functions as an output filter capacitor for DC output voltage V_{DC.3}.

FIG. 2 shows a schematic circuit diagram of a power converter according to an exemplary embodiment of the present invention.

Since the power converters depicted in FIG. 2 to 4 comprise the same or corresponding components or functional elements as the power converter depicted at FIG. 1, which have been described above in great detail, only additional features and components of exemplary embodiments of the present invention, which are depicted in FIGS. 2 to 4, are described below.

The controller circuit 40 of FIG. 2 comprises an additional fourth transformer winding n4. The two windings n2 and n4 of the transformer Tr1 are used for generating two AC voltages, a second AC voltage at the second transformer winding n2 and a fourth AC voltage at the fourth transformer winding n4, wherein the two AC voltages have opposite polarities. Inductors L2 and L3 each comprise two windings for the respective power inductor or magnetic amplifier. The series connection of C5 and C6 is stressed in this arrangement with only half of the lamp voltage, while the second half of the lamp voltage is supplied to C11 and C12. This arrangement has the advantage that parasitic capacitances between a fluorescent lamp and a grounded metal part, e.g. a reflector, may conduct less leakage current due to a lower electric field between lamp and ground. Furthermore, cables and connectors are also stressed only with half of the lamp voltage. This is of interest for LC displays of 30″ and more using very long and thin cold cathode fluorescent lamps with starting voltages of about 3000 volts peak and more.

It should be noted that the second controller circuit 4, inductor L3, capacitors C7, C8, C13 and C14 and the fourth transformer winding n4 operate in the same way as first controller circuit 3, C5, C6, C11, C12, L2 and n2, as described above.

FIG. 3 depicts a schematic circuit diagram of a power converter according to another exemplary embodiment of the present invention, wherein the rectifier circuit 50 comprises inductors L4, L5, diodes D4, D5, D6, D7, capacitors C15, C16 and output capacitor C17.

The rectifier circuit 50 depicted in FIG. 3 may be adapted to compensate additional changes of DC output voltage V_{DC.3} due to changes of the DC input voltage V_{DC.2} by means of a series resonant circuit, which is extended into a series-parallel resonant circuit. Without the implementation of the inductor L5, one would speak of a LCC-type resonant circuit in the rectifier circuit 50. This LCC-type resonant circuit may be designed such that it has a comparable AC-gain characteristic as the LC-type resonant circuit, which is implemented in the controller circuit 40 for driving a lamp of the backlighting. Using this, a voltage drop of the DC input voltage during a mains dip may be partly compensated by changing the switching frequency of the halfbridge circuit 30 by means of the second control circuit 2, which has been described above. Furthermore, the LCC-type resonant circuit may be extended, as has already been mentioned, into a LLCC-type resonant circuit by adding inductor L5 in order to reduce the reactive power flow resulting in a lower current stress of the transformer Tr1.

FIG. 4 shows a schematic circuit diagram of a power converter according to another exemplary embodiment of the present invention, further comprising a control circuit 5 and an opto coupler 7. Output voltage V_{DC.3} is measured by control circuit 5, which compares this voltage with a reference voltage. The output signal of the third control circuit 5 is an error signal which is transferred over mains isolation, e.g. by means of an opto coupler 7. The output signal of the opto coupler 7 is now the input signal of the voltage controlled oscillator in the second control circuit 2. This exemplary embodiment of the power converter makes maximum use of the available control parameters. The switching frequency of the two power semiconductors T2 and T3 is used in a control loop to regulate DC output voltage V_{DC.3}, while adjustable inductors are used to control the current in each lamp.

FIG. 5a shows a time-dependence of a gate-source voltage of a power semiconductor implemented in the halfbridge circuit 30 according to an exemplary embodiment of the present invention. As may be seen from FIG. 5a, the two power semiconductors T2 and T3 time-dependent gate-source voltages V_{GS}(t), wherein both gate-source voltages have equal conduction time intervals and are operated periodically. Both first and second power semiconductors T2 and T3 are operated with a non-overlap time interval of zero conduction between two consecutive conduction time intervals, in order to minimize the switching losses.

FIG. 5b shows the time-dependence of an internal halfbridge output voltage V_{A}(t) and the halfbridge output voltage of the first AC voltage V_{B}(t). Since capacitor C4 filters out the DC component of V_{A}(t) to generate a pure AC voltage, V_{B}(t), the first AC voltage V_{B}(t) oscillates between the peak values +V_{DC.2}/2 and −V_{DC.2}/2.

FIG. 6 shows the time-dependence of the output voltages of the second and fourth transformer windings n2 and n4, respectively, which have been described in FIG. 2. As may be seen in FIG. 6, the two output voltages V_{C}(t) and V_{D}(t) oscillate between the peak voltages +V_{amplitude} and −V_{amplitude} periodically with a period of 1/fs, wherein each of the two voltages has a different polarity.

FIG. 7 shows a schematic representation of a liquid crystal display 60 according to an exemplary embodiment of the present invention. The back side of the liquid crystal display 60 comprises a power converter according to an exemplary embodiment of the present invention (not shown in the figure). Backlighting systems of today's LCD-TVs, which comprise liquid crystal displays as the one schematically depicted in FIG. 7, often have display diagonals of 15″ to 40″ or more and use 4 to 20 or even more fluorescent lamps. The liquid crystal display of FIG. 7, which has implemented a power converter according to an exemplary embodiment of the present invention, allows for an independent control of each lamp and equal lamp currents with low tolerances. Furthermore, it provides the feature of so-called scanning backlight which may compensate for the sample and hold effect and thus motion blur of LCDs showing moving pictures.

1. Power converter, comprising: a controller circuit with at least one tuneable resonant circuit; wherein each tuneable resonant circuit of the at least one tuneable resonant circuit comprises a magnetic amplifier.

2. Power converter of claim 1, wherein each tuneable resonant circuit of the at least one tuneable resonant circuit is adapted to control the operation of a fluorescent gas discharge lamp.

3. Power converter of claim 2, further comprising: a halfbridge circuit for converting a DC input voltage into a first AC voltage, the halfbridge circuit comprising a first power semiconductor, a second power semiconductor, and a first control circuit; a first capacitor to convert a pulsating DC voltage into an AC voltage; wherein the first control circuit turns on the first and second power semiconductors periodically with equal conduction time intervals; wherein the first and the second power semiconductors are operated with a non overlap time interval of zero conduction between two consecutive conduction time intervals for a minimisation of switching losses; wherein the first AC voltage is supplied to a primary winding of a transformer for isolating the halfbridge circuit from the at least one tuneable resonant circuit; and wherein the at least one tuneable resonant circuit is connected to a second winding of the transformer.

4. Power converter of claim 3, further comprising a rectifier circuit for converting a third AC voltage into a DC output voltage, the rectifier circuit comprising: a third winding of the transformer for isolating the halfbridge circuit from the rectifier circuit; a series inductor; a plurality of series capacitors; wherein the third winding of the transformer supplies the third AC voltage to the rectifier circuit; wherein the series inductor and the plurality of series capacitors form a series resonant converter; and wherein the series resonant converter is tuned to the operation frequency of the rectifier circuit.

5. Power converter of claim 4, wherein each tuneable resonant circuit of the at least one tuneable resonant circuit is connected to the second winding and to a fourth winding of the transformer; wherein the second winding of the transformer supplies a second AC voltage with a first polarity and the fourth winding of the transformer supplies a fourth AC voltage with a second polarity; and wherein the first and second polarities are opposite.

6. Power converter of claim 4, wherein the halfbridge circuit comprises a second control circuit, and wherein the second control circuit controls the switching frequency of the halfbridge circuit as a function of the DC input voltage.

7. Power converter of claim 4, wherein the rectifier circuit comprises a full bridge diode rectifier and a series-parallel resonant circuit; wherein the series-parallel resonant circuit comprises a first inductor, a second inductor, a second capacitor, and a third capacitor; wherein the series-parallel resonant circuit is connected to the third winding of the transformer; wherein a first tuneable resonant circuit of the at least one tuneable resonant circuit provides a first frequency characteristic; wherein the rectifier circuit provides a second frequency characteristic; and wherein the first frequency characteristic and the second frequency characteristic correspond to each other.

8. Power converter of claim 7, comprising a feedback circuit, the feedback circuit comprising a third control circuit; wherein the third control circuit is adapted for adjusting the switching frequency of the halfbridge circuit in order to control the DC output voltage.

9. Power converter of claim 4, further comprising a mains rectifier circuit and a boost converter; wherein the mains rectifier circuit provides a first DC voltage to the boost converter; and wherein the boost converter provides a DC input voltage to the halfbridge circuit.

10. Liquid crystal display, the liquid crystal display comprising a power converter, the power converter comprising: a controller circuit with at least one tuneable resonant circuit; wherein each tuneable resonant circuit of the at least one tuneable resonant circuit comprises a magnetic amplifier.

11. Liquid crystal display of claim 10, further comprising: a halfbridge circuit for converting a DC input voltage into a first AC voltage, the halfbridge circuit comprising a first power semiconductor, a second power semiconductor, and a first control circuit, a first capacitor to convert a pulsating DC voltage into an AC voltage; a controller circuit with at least one tuneable resonant circuit; wherein the first control circuit turns on the first and second power semiconductors periodically with equal conduction time intervals; wherein the first and the second power semiconductors are operated with a non overlap time interval of zero conduction between two consecutive conduction time intervals for a minimisation of switching losses; wherein the first AC voltage is supplied to a primary winding of a transformer for isolating the halfbridge circuit from the at least one tuneable resonant circuit; wherein the at least one tuneable resonant circuit is connected to a second winding of the transformer; wherein each tuneable resonant circuit of the at least one tuneable resonant circuit comprises a magnetic amplifier; and wherein each tuneable resonant circuit of the at least one tuneable resonant circuit controls the operation of a fluorescent lamp.
